(19) United States
(12) Patent Application Publication
(10) Pub. No.: US 2002/0140962 A1
(43) Pub. Date: Oct. 3, 2002

(54) Printer system

(76) Inventor: Ryuichi Oka, Chiba-shi (JP)

Correspondence Address: ADAMS & WILKS, 31st FLOOR, 50 BROADWAY, NEW YORK, NY, 10004, US

(21) Appl. No.: 10/068,481

(22) Filed: Feb. 7, 2002

(30) Foreign Application Priority Data
Mar. 30, 2001 (JP) 2001-100754

(51) Int. Cl. G06F 3/12; G06F 13/00

(52) U.S. Cl. 358/1.14; 358/1.15; 710/18; 710/19

(57) ABSTRACT

A printer has a host computer provided with a communications control unit for performing polling monitoring and sending control of print data and a control command to a printer. A print control unit generates the print data and the control command, and a command analysis unit analyzes the content of status information sent from the printer in response to sending of a status request command in the polling monitoring. An access interval alteration unit alters the interval at which the status request command is sent to the printer based on the result of the polling monitoring by the communications control unit. The printer is provided with a communications control unit for supporting bi-directional communications with the host computer, a status control unit for controlling generation of printer status information in response to the status request command that is sent accompanying execution of the polling monitoring by the host computer, a print data analysis unit for analyzing the print data, and a print execution unit for executing printing based on the analyzed print data.

### BACKGROUND OF THE INVENTION

1. Field of the Invention

The present invention relates to a printer system in which polling monitoring is conducted between a host computer serving as a monitoring device and a printer serving as a monitored device, in which the host computer accesses the printer at predetermined intervals, to grasp current status of the printer, and the printer executes printing operations according to print data and a control command sent from the host computer to the printer based on the results of the polling monitoring.

2. Description of the Related Art

There is a printer connected to a host computer by means of a USB (Universal Serial Bus) and a Centronics-standard parallel interface in such a way as to be capable of bi-directional communications. In such a printer, as one of the methods in which the host computer obtains printer status information, there is a technique in which, a host computer serves as a monitoring device and a printer serves as a monitored device, and polling monitoring is performed in which the host computer accesses the printer at predetermined intervals, to thereby obtain the status information from the printer.

That is, the printer is constructed so as to be able to interpret and execute a status request command as a control command, and when the printer receives this control command from the host computer, it sends the status information to the host computer.

In order to obtain the status information by means of the polling monitoring such as that described above, the host computer accesses the printer at the predetermined intervals (for example, every 5 seconds) and sends the status request command.

However, there is a problem that, when the polling intervals (i.e., the access intervals) in the polling monitoring are long, the host computer becomes slow in verifying the time when the status of the printer has changed, and thus its response at the time when a printer abnormality has been detected or when printing can be executed becomes slow.

In contrast, there is a problem that, when the polling intervals are short, the printer must respond to the status request command being sent frequently from the host computer, and thus the load on the printer controller becomes great and the print processing speed declines. Meanwhile, even on the host-computer side, the status request command is issued frequently, with the result that throughput declines. In particular, in the case where the printer status does not change for a relatively long period of time, the host computer receives status information with the same content successively, and thereby repeats unnecessary analysis of the status information.

### SUMMARY OF THE INVENTION

The present invention was devised to solve the above-mentioned problems, and an object of the present invention is to provide a printer system capable of speeding up a response at a time when a printer abnormality is detected and a time when printing can be performed, and is also capable of improving throughput during printing.

In order to achieve the above objects, a printer system according to the present invention is a printer system in which polling monitoring is conducted between a host computer (C) serving as a monitoring device and a printer (P) serving as a monitored device, in which the host computer accesses the printer at predetermined intervals to grasp the current status of the printer, and the printer executes printing operations according to print data and a control command sent from the host computer to the printer based on the results of the polling monitoring, wherein the host computer is provided with at least a communications control means (communications control unit 100) for performing polling monitoring and sending control of print data and a control command to the printer; a print control means (print control unit 102) for performing generation and the like of the print data and the control command; a command analysis means (command analysis unit 103) for analyzing content of status information sent from the printer in response to sending of the status request command in the polling monitoring; and an access interval alteration means (timer control unit 104 and timer execution unit 105) for altering the interval at which the status request command is sent to the printer based on the result of the polling monitoring by the communications control means; wherein the printer is provided with at least a communications control means (communications control unit 200) for supporting bidirectional communications with the host computer; a status control means (status control unit 201) for controlling generation of printer status information in response to the status request command accompanying execution of the polling monitoring by the host computer; a print data analysis means (print execution unit 202) for analyzing the print data; and a print execution means (print execution unit 202) for executing printing based on the analyzed print data.

Accordingly, the host computer can alter the interval at which the status request command is sent to the printer by means of the access interval alteration means based on the result of the polling monitoring; therefore, it is possible to make the access interval changeable according to the printer status. That is, as a result of the polling monitoring, in the case where the printer abnormality is detected or in the case where “busy” status has been detected, for example, the access interval is shortened, thereby producing the result that the confirmation of the printer status can be performed frequently; and in the case where the printer is normal, the access interval is lengthened to decrease the load from the status information analysis and the like, thereby improving throughput.

Further, the access interval alteration means is comprised of a timer for determining the access interval and a timer control means for controlling the timer; and in the case where the status information sent from the printer indicates an abnormality in the printer itself or a communications abnormality, or in the case where it indicates that the printer is in busy status, the timer control means can alter the timer access intervals so that the intervals become shorter than the timer access intervals in the case where the status information indicates that the printer is in normal status. Accordingly, in the case where the printer is normal, the access intervals are lengthened and thus the load of the status information analysis and the like is decreased to improve the throughput; and in the case where the printer abnormality or the communications abnormality has been detected, or in the case where the busy status has been detected, the access intervals are shortened, whereby the confirmation of the printer status can be performed more frequently and the response to the printer status can be speeded up.

### BRIEF DESCRIPTION OF THE DRAWINGS

In the accompanying drawings:

FIG. 1 is a block diagram showing a schematic construction of a control system of a printer system S to which the present invention is applied; and

FIG. 2 is a flow chart showing a processing procedure of status obtaining processing executed on a host computer C.

### DETAILED DESCRIPTION OF THE PREFERRED EMBODIMENTS

Hereinafter, explanation will be made of a preferred embodiment of the present invention based on the drawings.

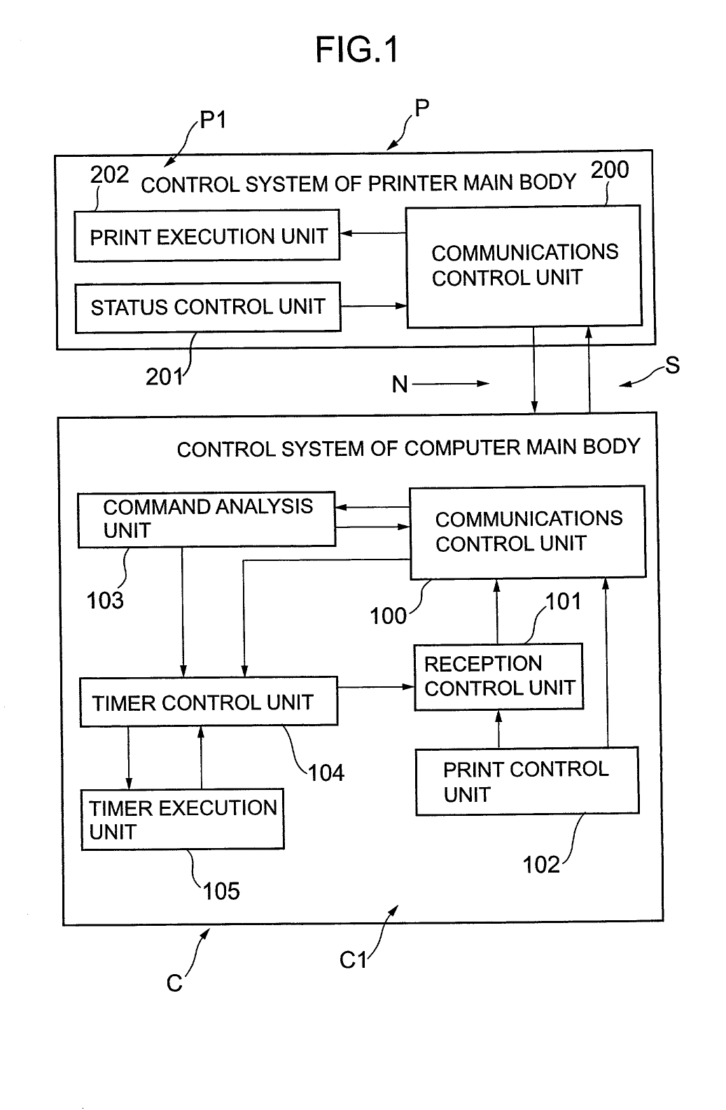

FIG. 1 is a block diagram showing a schematic construction of a control system of a printer system S according to the present invention.

The printer system S is composed of a host computer C serving as a monitoring device and a printer P serving as a monitored device. The host computer C performs polling monitoring on the printer P at predetermined intervals and grasps current status of the printer P. The printer P executes printing operations according to print data and a control command sent to the printer P from the host computer C based on the results of the polling monitoring.

As a system to which the present invention can be applied, for example, using a general personal computer or the like as the host computer C is conceivable. Further, a control system Cl on the host computer C side which will be discussed below is composed of: a CPU which is a central processing unit provided to the host computer C; a memory (RAM) which constitutes a work area and the like; and software (a printer driver or the like) for using hardware resources such as a hard disk, for example, for storing a variety of programs and data.

The control system Cl on the host computer C side is composed of: a communications control unit 100 for executing the polling monitoring and sending control of the print data and the control command (i.e., status request command), to the printer P; a reception control unit 101 for controlling reception of the status information and the like sent from the printer P; a print control unit 102 for executing generation and the like of the print data and the control command; a command analyses unit 103 for analyzing content of the status information sent from the printer P in response to the sending of the status request command in the polling monitoring; a timer control unit 104 which constitutes an access interval alteration means for altering the interval at which the status request command is sent to the printer P based on the results of the polling monitoring performed by the communications control unit 100; and a timer execution unit 105 for determining the access interval.

In the case where the status information sent from the printer P indicates a normal condition of the printer P, the timer control unit 104 sets the access interval of the timer execution unit 105 relatively long at, for example, 7 seconds; and in the case where the status information indicates busy status of the printer P or status of abnormality occurrence of the printer itself or an abnormality of the status request command, the timer control unit 104 alters the access interval of the timer execution unit 105 so as to be relatively short at, for example, 1 second.

On the other hand, the printer P is a thermal printer, an ink jet-type printer, a laser printer or the like, and it is equipped with a printer engine (not shown) for executing printing corresponding to each printing system.

Further, a control system P1 of the printer P is composed of: a communications control unit 200 for supporting bi-directional communication with the host computer C; a status control unit 201 for controlling generation of the status information of the printer P in response to the status request command which accompanies the polling monitoring that is performed by the host computer C; and the print execution unit 202 for analyzing the print data and executing printing by means of the printer engine based on the analyzed print data. Note that, the above-mentioned control system P1 may be composed of, for example, one-chip microcomputer or the like.

The above-mentioned host computer C and the above-mentioned printer P are connected to each other by means of a USB (Universal Serial Bus), a Centronics-standard parallel interface and the like, via a communications line N which is capable of bi-directional communications.

Here, explanation will be made of an operation of the control system C1 on the above-mentioned host computer C.

First, in the case where the print data exists, the print control unit 102 issues a sending request to the communications control unit 100 for the print data to be sent to the printer, and simultaneously makes a request to the reception control unit 101 for the status information to be received. After the communications control unit 100 has received the sending request for the print data to be sent, it opens a communications line N in order to perform communications with the printer P and starts the sending of the print data. Further, after the reception control unit 101 has received the request for the status information to be received, it requests that the communications control unit 100 receive the data from the printer P. After the communications control unit 100 has been requested to receive the status information, it sends the status request command to the printer P during an interval in the sending of the print data and then executes the reception of the status information. Then, in the case where the communications control unit 100 was able to receive the status information from the printer P, it transfers the data thereof to the command analysis unit 103. The command analysis unit 103 analyses the status information, and in the case where a data abnormality (communication abnormality) or a printer abnormality is detected, it informs the timer control unit 104 of the abnormality. Further, in the case where the command analysis unit 103 did not detect the abnormality, it informs the timer control unit 104 of the normal status. Further, in the case where it was determined that the printer P is outputting a busy signal, the communications control unit 100 informs the timer control unit 104 of this, too. In the case where the busy signal continues for a predetermined duration of time or longer, then the timer control unit 104 determines that there is an abnormality in the printer P.

Next, in the case where the timer control unit 104 has been notified of the normal status by the command analysis unit 103, the timer control unit 104 sets the timer execution unit 105 relatively long at, for example, 7 seconds; and in the case where it has been informed of the abnormality, it sets the timer execution unit 105 relatively short at, for example, 1 second, and then begins to count the duration of time which has been set respectively. When the set duration of time is completed, the timer execution unit 105 informs the timer control unit 104 that the timer execution unit 105 has timed out. When this occurs, the timer control unit 104 makes the reception control unit 101 execute the reception of the status information each time the timer times out. As a result, the status information can be received at a short interval when there is an abnormality, and at a long interval when the status is normal.

Thereafter, the above operations are repeatedly executed until the command analysis unit 103 determines that the printing has ended. Then, when the command analysis unit 103 determines that the printing has ended, the command analysis unit 103 informs the communications control unit 100 that the sending has ended, closes the communications line N and ends a series of printing procedures.

Next, explanation will be made of operations of the control system P1 of the printer P.

First, in the case where the communications control unit 200 has received the print data sent from the communications control unit 100 on the host computer C side, the communications control unit 200 transfers the print data to the print execution unit 202. After the print execution unit 202 has received the print data, it analyzes the print data and executes the printing by means of the print engine.

The status control unit 201 constantly monitors the condition (status) of the printer P, and in the case where some sort of change has occurred in the internal condition of the printer P, the status control unit 201 transfers the status information to the communications control unit 200.

When the communications control unit 200 receives the status request command sent from the communications control unit 100 on the host computer C side, in the case where the status information has been received from the status control unit 201, the communications control unit 200 sends this status information to the communications control unit 100 on the host computer C side. On the other hand, when the status request command is sent over, in the case where the status control unit 201 has not received the status information, the communications control unit 200 sends to the communications control unit 100 on the host computer C side a 0-length data (i.e., data having a data length of 0 bytes), which indicates that the communications control unit 200 has no data to reply with.

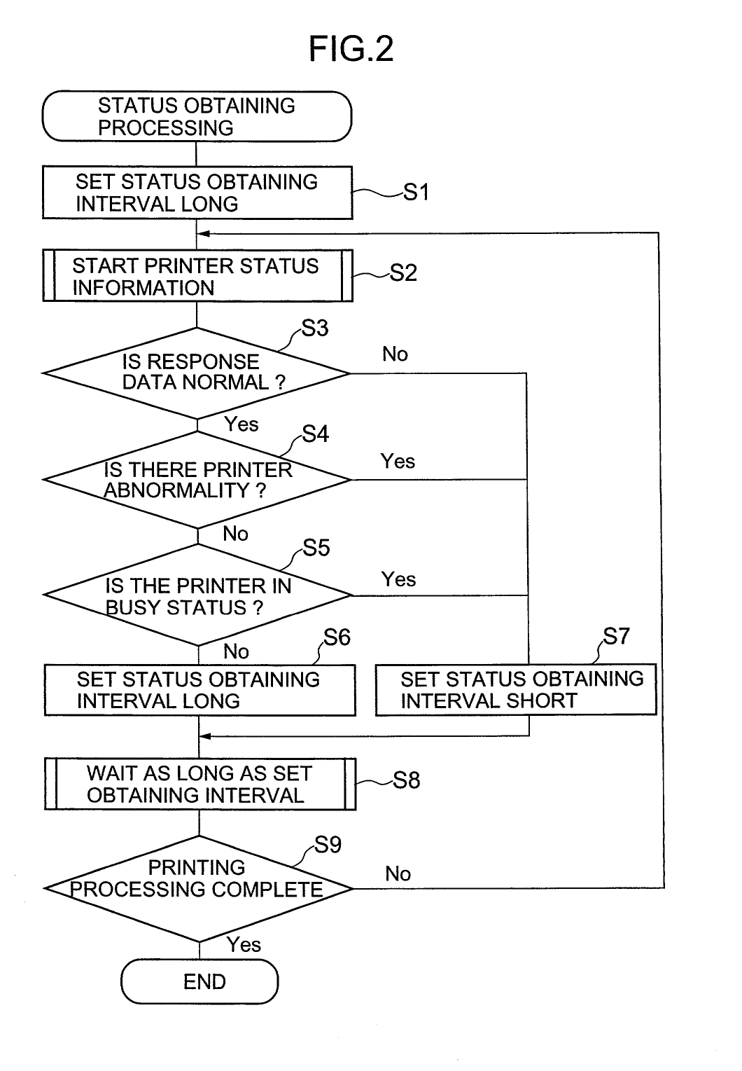

Next, detailed explanation will be made of the above status obtaining processing, which is performed by the host computer C, making reference to the flow chart of FIG. 2. FIG. 2 is a flow chart showing a processing procedure of the status obtaining processing.

In this processing, first, at step S1 a status obtaining interval (i.e., the access interval) is set relatively long at 7 seconds, for example, and then the processing transits to step S2 and the obtaining of the printer status information is started. At step S3, a determination is made as to whether response data (i.e., status information) is normal or not, and in the case where there is an abnormality in the data, there is a possibility that the abnormality has occurred in the printer P or in the communications line N or the like; therefore, the processing transits to step S7, the status obtaining interval (i.e., the access interval) is set short at, for example, 1 second, and the status request command is immediately resent to thereby reconfirm whether the abnormality has actually occurred in the printer P.

On the other hand, in the case where the status information was determined to be normal at step S3, the processing transits to step S4, the content of the status information is analyzed, and it is determined whether or not there is the abnormality in the printer P. Then, in the case where it is determined that there is an abnormality in the printer P, the processing transits to step S7, the status obtaining interval is set to be short at, for example 1 second, and monitoring is performed sequentially to determine whether or not the printer P has returned to the normal status. Further, in the case where it has been determined that there is no abnormality in the printer, the processing transits to step S5.

At step S5, a determination is made as to whether the printer P is in the busy status or not, and in the case of “Yes”, the processing transits to step S7, the status obtaining interval is set short at 1 second, for example, and the monitoring is performed sequentially to determine whether or not the busy status of the printer P has been released and is in a state capable of printing. Further, in the case of “No” at step S5, the processing transits to step S6, and in the case where the status obtaining interval is 7 seconds, this state is maintained; and in the case where the status obtaining interval is set at the 1-second interval, the interval is altered to the 7-second interval, whereby the load and the like in analyzing the status information is alleviated to improve throughput.

After the completion of step S6 and step S7, the processing transits to step S8 and waits for a duration of time which is as long as the status obtaining interval which was set at step S6 or step S7 (which is counted by the timer execution unit 105) before advancing to step S9. At step S9, a determination is made as to whether the print processing has completed or not, and in the case of “No”, the processing returns to step S2 and repeats the above processing; and in the case of “Yes”, the status obtaining processing is ended.

According to the printer system S of the present embodiment which has been described above, in the case where the printer P is normal, the status obtaining interval (i.e., the access interval) can be lengthened to decrease the load and the like in analyzing the status information and the throughput can be improved; and in the case where the abnormality or the busy status of the printer P has been detected, for example, the access interval can be shortened to thereby perform confirmation of the status of the printer P frequently and accelerate the response to the printer condition.

A concrete explanation of the invention made by the present inventor has been provided above based on the embodiment; however, the present invention is not limited to the above embodiment, and a variety of modifications are possible without departing from the gist thereof.

For example, the access interval is not limited to the case in which the relatively short interval is set at 1 second and the relatively long interval is set at 7 seconds as in the present embodiment. For example, it is possible to make alterations as necessary, such as setting the relatively short interval to 0.5 seconds and the relatively long interval to 5 seconds. Further, the access interval may be altered in accordance with the printer type and the like as necessary.

As described above, the printer system according to the present invention is a printer system in which polling monitoring is conducted between a host computer serving as a monitoring device and a printer serving as a monitored device, in which the host computer accesses the printer at predetermined intervals to grasp the current status of the printer, and the printer executes printing operations according to print data and a control command sent from the host computer to the printer based on the results of the polling monitoring, wherein the host computer is provided with at least: a communications control means for performing polling monitoring and sending control of print data and a control command to the printer; a print control means for performing generation and the like of the print data and the control command; a command analysis means for analyzing content of status information sent from the printer in response to sending of the status request command in the polling monitoring; and an access interval alteration means for altering the interval at which the status request command is sent to the printer based on the result of the polling monitoring by the communications control means; and the printer is provided with at least: a communications control means for supporting bidirectional communications with the host computer; a status control means for controlling generation of printer status information in response to the status request command that is sent accompanying execution of the polling monitoring by the host computer; a print data analysis means for analyzing the print data; and a print execution means for executing printing based on the analyzed print data. Accordingly, the host computer can alter the interval at which the status request command is sent to the printer, by means of the access interval alteration means based on the result of the polling monitoring; therefore, it is possible to make the access interval changeable according to the printer status. That is, as a result of the polling monitoring, there can be obtained an effect in which, in the case where the printer abnormality is detected or in the case where busy status has been detected, for example, the access interval can be shortened, so that the confirmation of the printer status can be performed frequently; and in the case where the printer is operating normally, the access interval can be made longer to decrease the load from the status information analysis and the like, thereby improving throughput.

What is claimed is:

1. A printer system, wherein polling monitoring is conducted between a host computer serving as a monitoring device and a printer serving as a monitored device, in which the host computer accesses the printer at predetermined intervals to grasp current status of the printer, and the printer executes printing operations according to print data and a control command sent from the host computer to the printer based on results of the polling monitoring;
the host computer comprising:
a communications control means for performing polling monitoring and sending control of print data and a control command to the printer;
a print control means for performing generation and the like of the print data and the control command;
a command analysis means for analyzing content of status information sent from the printer in response to sending of the status request command in the polling monitoring; and
an access interval alteration means for altering the interval at which the status request command is sent to the printer based on the result of the polling monitoring by the communications control means; and
the printer comprising:
a communications control means for supporting bidirectional communications with the host computer;
a status control means for controlling generation of printer status information in response to the status request command that is sent accompanying execution of the polling monitoring by the host computer;
a print data analysis means for analyzing the print data; and
a print execution means for executing printing based on the analyzed print data.

2. A printer system according to claim 1, wherein the access interval alteration means is comprised of a timer for determining access interval and a timer control means for controlling the timer; and
the timer control means can, in a case where the status information sent from the printer indicates an abnormality in the printer itself or a communications abnormality or in a case where it indicates that the printer is in busy status, alter timer access intervals so that the intervals become shorter than those in a case where the printer indicates normal operation status.
